(19) United States
(12) Patent Application Publication
(10) Pub. No.: US 2007/0084013 A1
(43) Pub. Date: Apr. 19, 2007

(54) Elastic hinge barrel mask

(76) Inventor: Frank Henrich, Modesto, CA (US)

Correspondence Address: INDIANAPOLIS OFFICE 27879;BRINKS HOFER GILSON & LIONE, ONE INDIANA SQUARE, SUITE 1600, INDIANAPOLIS, IN, 46204-2033, US

(21) Appl. No.: 11/583,389

(22) Filed: Oct. 18, 2006

Related U.S. Application Data
(60) Provisional application No. 60/728,286, filed on Oct. 19, 2005.

(51) Int. Cl. E05D 11/00

(52) U.S. Cl. 16/250; 16/258

(57) ABSTRACT

A hinge mask for protecting the pin barrel portion of a door hinge during application of a liquid coating to adjacent portions of a door and/or frame to which the door hinge is attached takes the form of a elastic band having at least one open side, and a length in a relaxed state that is shorter than the length of the door hinge to which the band is to be applied. The elastic band has sufficient elasticity to permit lengthwise stretching of the band to a distance sufficient to allow one side of the band to be applied over the pin barrel portion of the door hinge and into contacting relationship with the adjacent door and frame. The elastic band has a sufficient width dimension measured between the two sides so that, when the elastic band is applied over the pin barrel portion of the door hinge, a side that is not in contact with the pin barrel returns to a substantially relaxed state to form an overlapping structure preventing application of the liquid coating to the pin barrel portion of the door hinge.

### CROSS-REFERENCE TO RELATED APPLICATIONS

The present invention relates to and claims all available benefit from U.S. Provisional Application 60/728,286, filed Oct. 19, 2005, which is a continuation of U.S. Provisional Application 60/728,286, filed Nov. 10, 2004.

### BACKGROUND

1. Technical Field

The present invention relates generally to a masking element for protecting the pin barrel portion of a door hinge during application of a liquid coating, such as a paint, stain or other similar liquid, to adjacent portions of a door or frame to which the door hinge is attached.

2. General Background

Masking devices for protecting door hinges are well known. For example, U.S. Pat. No. 4,796,330 discloses a two-part hinge mask, each part consisting of a sheet of covering material with an adhesive coating facing a release sheet. The hinge mask is of fixed dimension and a mask suitable to a particular job must be selected from one of several standard sizes, or specially manufactured. U.S. Pat. No. 5,056,191 is similarly constructed, but the perimeter shape of the mask is somewhat different. U.S. Pat. No. 5,722,120 is also similarly constructed, but is intended for use on only half a hinge when the door and frame and not joined together by a pin passing though the intersecting barrel portions. Again, all these hinge masks are of fixed dimension and a mask suitable to a particular job must be selected from one of several standard sizes, or specially manufactured.

U.S. Pat. No. 4,921,028 discloses a hinge mask made of a flexible material such as plastic or paper having an adhesive strip along two edges. The length of one of the adhesive edges should be about the same as the height of the hinge, thus requiring manufacture or trimming to size to approximate the hinge dimension. U.S. Pat. No. 6,745,435 discloses a hinge mask having an adhesive strip protruding from a central portion intended to envelope the pin barrel of a door hinge, and two wing-like portions having adhesive surfaces protected by release sheets that are intended to bond to the hinge plate. At least the two wing-like portions must be suitably dimensioned to the specific size of the hinge.

U.S. Pat. No. 5,198,031 discloses a hinge mask made of flexible magnetic elements that are designed to be magnetically attracted to the door hinge and are selectively dimensioned to one of several selected sizes. Such a hinge mask is not operative on brass or stainless steel due to the lack of magnetic attraction. Further, the hinge mask is of fixed dimension and a mask suitable to a particular job must be selected from one of several standard sizes, or specially manufactured.

U.S. Pat. No. 5,224,240 discloses a hinge mask intended for use on a hinge when the door in not connected to the frame with a pin through the connected barrel. The mask is a one piece rigid molded plastic body including a thin hinge portion permitting two half-cylinder concave body portions to envelope the barrel, and a tab portion that extends over the hinge plate. Another hinge mask formed of a rigid molded plastic is to be found in U.S. Pat. No. 6,165,269 that included a tapered edge intended to cover as little of the surface of the adjacent door or jam as possible. Once again, these hinge masks are of fixed dimension and a mask suitable to a particular job must be selected from one of several standard sizes, or specially manufactured.

U.S. Pat. No. 4,691,409 discloses a hinge barrel mask constructed of a complex junction of elastic portions that can be taken from two elongated balloons that are cut and adhesively bonded together is a rather complex pattern together with hooks or other fasteners. While the elastic character of the construction permits the adaptation of the mask to hinge barrels having a variety of lengths, the mass production of such a complex structure would be difficult to accomplish, and the hand manufacture of such items would make the cost of such masks prohibitive.

Thus there remains a need for a low-cost hinge barrel mask that accommodates a range of sizes. There is a particular need for such a hinge barrel mask that can be used with pre-hung doors that are used in large volume in large sub-division, or apartment building construction.

### BRIEF SUMMARY

A hinge mask of the present invention is intended to protect merely the pin barrel portion of a door hinge during application of a liquid decorative or protective coating, which may be in the form of an aerosol spray, to adjacent portions of a door and frame to which the door hinge is attached. The hinge mask of the present invention takes the form of a elastic band that can have two open sides, the elastic band having a length in a relaxed state that is shorter than the length of the door hinge to which the band is to be applied. The elastic band has sufficient elasticity to permit lengthwise stretching of the band to a distance sufficient to allow one open side of the band to be applied over the pin barrel portion of the door hinge and into contacting relationship with the adjacent door and frame. The elastic band has a sufficient width dimension measured between the two open sides so that, when the elastic band is applied over the pin barrel portion of the door hinge, the side that is not in contact with the pin barrel returns to a substantially relaxed state. In the relaxed state, a second open side will generally form an overlapping structure preventing application of the liquid coating to the pin barrel portion of the door hinge.

The width of the elastic band forming the pin barrel mask of the present invention is preferably at least about twice the distance from the door surface to the pin barrel portion outer margin to provide sufficient width to allow the formation of the overlapping structure. This width also makes installation and removal of the mask very easy. The relaxed overlapping structure is shorter than the length of the barrel portion of the hinge so that the overlapping structure provides little, if any, barrier to the adjacent portions of the door and jamb. The thickness of the elastic band is sufficiently small to avoid covering any significant area of the door surface. It has been found that a elastic band having thickness in the relaxed state of less than 0.89 mm, and preferably about 0.76 mm or less, covers such an insignificant area of the door and jamb as to be un-noticeable. This is particularly true if, in application of the elastic band to the door hinge structure, the elastic band is stretched lengthwise by a factor of at least about 15%.

The elastic band forming the hinge barrel mask of the present invention can be made of a variety of elastic polymers, including natural and synthetic rubbers, particularly in latex form, that can be molded to a desired preform shape using a dipping process, and then cut to form the finished product. A suitable material for forming a band of the present invention capable of resisting the various solvents in coatings commonly applied to doors is nitrile butadiene rubber. The resulting structure can be made quickly and at low cost. The resulting hinge barrel mask is quickly and easily applied without the mess or fuss of adhesives that may leave residues. One size of hinge barrel mask of the present invention is suitable for use on a wide variety of hinge sizes, thus significantly reducing the variety of inventory that must be maintained, often to only a single size.

Additional features and advantages of the present invention will become apparent from a review of the following description along with a consideration of the accompanying drawings that are referred to in the following description of a preferred embodiment.

### BRIEF DESCRIPTION OF THE DRAWINGS

FIG. 1 is a perspective view of a first preferred embodiment of the invention.

FIG. 2 is a perspective view of a second preferred embodiment of the invention.

FIG. 3 is a perspective view of an exposed pin barrel of a door hinge prior to installation of the invention.

FIG. 4 is a perspective view of the first preferred embodiment installed on the pin barrel shown in FIG. 3.

### DESCRIPTION OF THE PREFERRED EMBODIMENTS

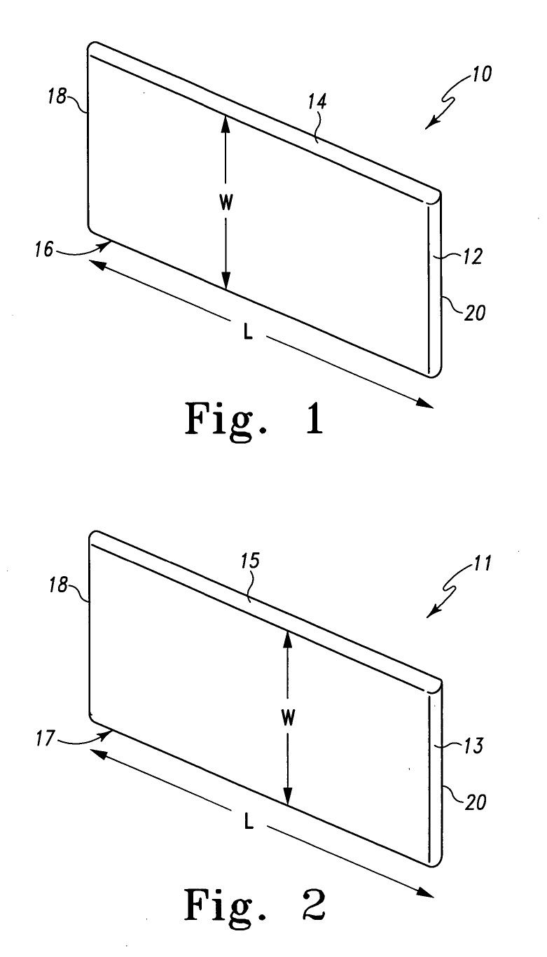

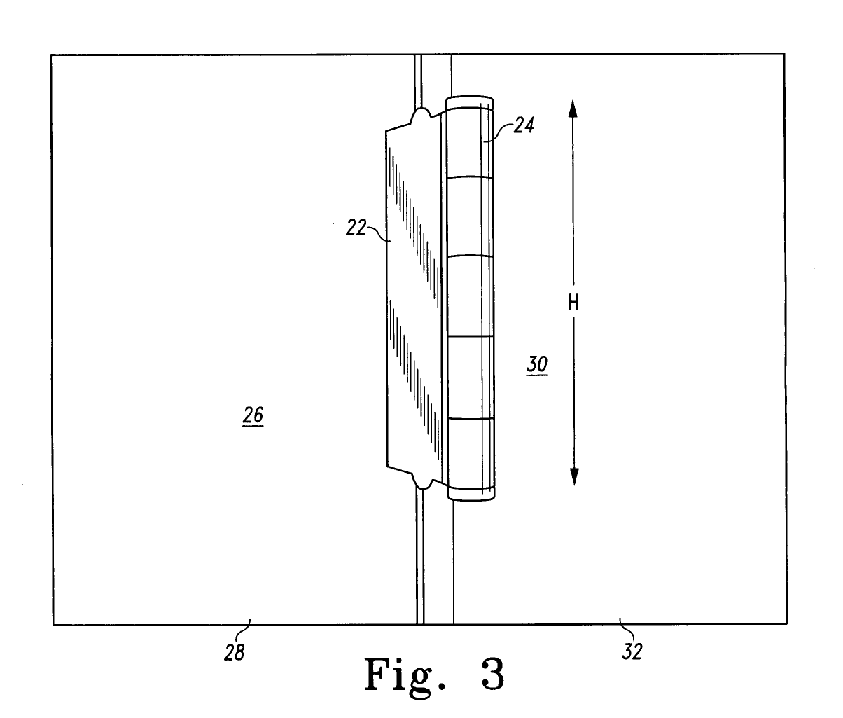

A hinge mask 10 of the present invention can take the form of an elastic band 12 as shown in FIG. 1 that has two open sides 14 and 16. Another hinge mask 11 of the present invention can take the form of an elastic band 13 as shown in FIG. 2 that has an open side 15 and a closed side 17. Each of the elastic bands 12 and 13 has a length L, measured between ends 18 and 20, which in a relaxed state, is shorter than the length of the door hinge 22 to which the band 12 is to be applied. A typical door hinge 22 is shown in FIG. 3 to include a barrel portion 24 protruding beyond the surface 26 of the door 28 and the surface 30 of the door frame 32. The vertical dimension H of the barrel portion 24 exceeds the length L of the mask 10 or 11 selected to be applied to the door hinge 22.

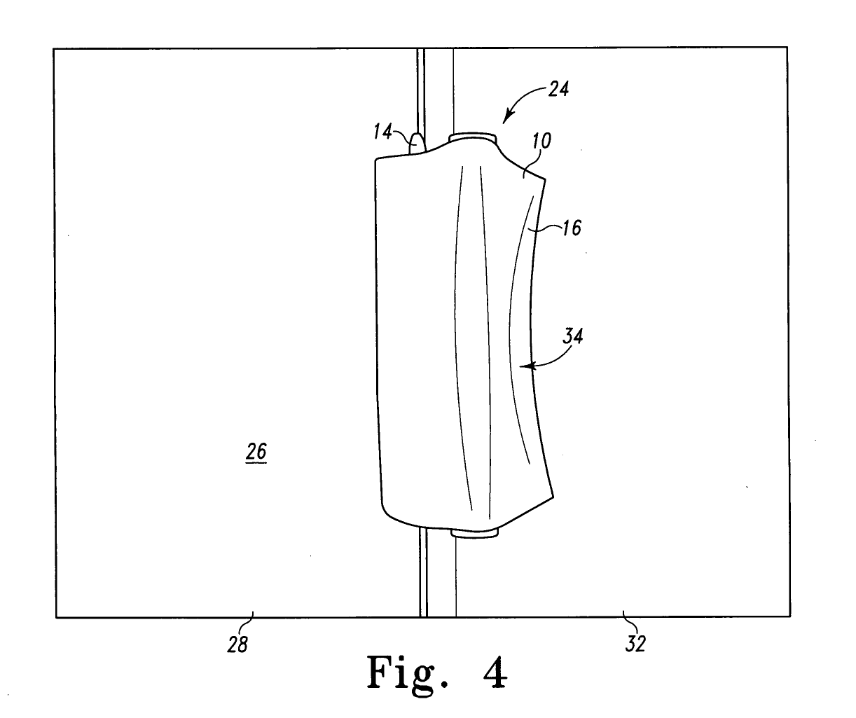

The hinge masks 10 and 11 have sufficient elasticity to permit lengthwise stretching of the masks 10, 11 to a distance sufficient to allow one open side 14, 15 of the mask to be applied over the pin barrel portion 24 of the door hinge 22 as shown in FIG. 4. Desirably the edge defining the open side 14, 15 is brought merely into contacting relationship with the adjacent door 28 and frame 32 so that a negligible surface area of the door 28 or frame 32 is obscured by the mask. To minimize the area being obscured, the thickness of the elastic band 12, 13 in the relaxed state should generally be less than about 0.5 mm and preferably less than about 0.1 mm. The elastic band 12 forming mask 10 has a sufficient width dimension W measured between the two open sides 14, 16 so that, when the elastic band 12 is applied over the pin barrel portion 24 of the door hinge 22, the side 16 that is not in contact with the pin barrel 24 returns to a substantially relaxed state as shown in FIG. 4. In the relaxed state, a second open side 16 will generally form an overlapping structure 34 as shown in FIG. 4 preventing application of any coating material to the pin barrel portion 24 of the door hinge 22.

An example of a elastic band 12 that performed satisfactorily was made of a synthetic rubber latex material of 0.4 mm thickness, using a dipping process, the band 12 having a length L of 64 mm and a width W of 44 mm. Various lengths and widths can be adopted to conform under tension as described previously to the dimensions of the pin barrel portion 24. The mask 10, 11 of the present invention can applied to and removed from the pin barrel of the door hinge much more quickly than conventional masking tape or other specialized masking elements, leaving no residue behind after removal. The mask 10, 11 can be reused for the same purpose, yet can be manufactured at sufficiently low cost to permit treatment as a disposable item.

The foregoing detailed description should be regarded as illustrative rather than limiting, and the following claims, including all equivalents, are intended to define the spirit and scope of this invention.

1. A masking device for protecting a pin barrel portion of a door hinge during application of a liquid coating to adjacent portions of a door and frame to which the door hinge is attached, the masking device comprising:
a elastic band having at least one open side, the elastic band having a length in a relaxed state that is shorter than the length of the door hinge to which the band is to be applied, the elastic band having sufficient elasticity to permit lengthwise stretching of the band to a distance sufficient to allow an open side of the band to be applied over the pin barrel portion of the door hinge and into contacting relationship with the adjacent door and frame, the elastic band having a sufficient width dimension measured between the two sides so that when the elastic band is applied over the pin barrel portion of the door hinge a side that is not in contact with the pin barrel returns to a substantially relaxed state.

2. The masking device of claim 1 wherein the width of the elastic band is at least about twice the distance from the door surface to the pin barrel portion outer margin.

3. The masking device of claim 1 wherein the thickness of the elastic band is sufficiently small to avoid covering any significant area of the door surface.

4. The masking device of claim 3 wherein the thickness of the elastic band in a relaxed state is less than 0.089 cm.

5. The masking device of claim 1 having only a single open side.

6. The masking device of claim 2 having two open sides.

7. A method of masking a door hinge barrel situated on a door and/or frame comprising the steps of:
selecting an elastic band having at least one open side, the elastic band having a length in a relaxed state that is shorter than the length of the door hinge to which the band is to be applied, and having a side-to-side width that is greater than the distance from the door surface to the barrel outer margin,
stretching of the band to a distance sufficient to allow an open side of the band to be applied over the pin barrel portion of the door hinge and into contacting relationship with the adjacent door and/or frame, and
allowing the side of the band that is not in contact with the pin barrel to return to a substantially relaxed state to form a structure preventing application of any liquid coating to barrel portion of the door hinge.

8. The method of claim 7 wherein the stretching step stretches the band by at least 15%.
